(19) United States
(12) Patent Application Publication
(10) Pub. No.: US 2026/0033441 A1
(43) Pub. Date: Feb. 5, 2026

(54) APPARATUS AND METHOD FOR TRANSPORTING WOOD IN STEEP TERRAIN

(71) Applicants: Konrad Forsttechnik GmbH, Preitenegg (AT); Ecoforst GmbH, Tragöß-St.Katharein (AT)

(72) Inventor: Markus KONRAD, Preitenegg (AT)

(73) Assignees: Konrad Forsttechnik GmbH, Preitenegg (AT); Ecoforst GmbH, Tragöß-St.Katharein (AT)

(21) Appl. No.: 19/115,596

(22) PCT Filed: Jul. 6, 2023
(86) PCT No.: PCT/AT2023/060223

§ 371 Date: Mar. 26, 2025

(30) Foreign Application Priority Data
Oct. 3, 2022 (AT) A 50762/2022

(51) Int. Cl. A01G 23/00; B66D 3/26

(52) U.S. Cl. CPC A01G 23/006; B66D 3/26

(57) ABSTRACT

to an apparatus and method for transporting wood in steep terrain, the apparatus including a mobile winch and a mobile transport vehicle which connectable to the winch via a cable and has a chassis. The winch includes a winch drive for winding and unwinding the cable and the transport vehicle includes a travel drive for driving the chassis. The transport vehicle and the winch are connected by a data connection. Further, the transport vehicle includes a sensor for determining a direction of travel relative to the cable winch and a data processing device is provided which is connected to the travel drive and the winch drive so that, using the data processing device, a cable speed and a travel drive speed can be adjusted in an automated manner depending on a direction of travel of the transport vehicle.

The invention relates to an apparatus for transporting wood in steep terrain.

The invention furthermore relates to a method for transporting wood in steep terrain using an apparatus.

From the prior art, apparatuses and methods of the type named at the outset have become known, wherein, for example, a stationary winch and a mobile transport vehicle interact in order to be able to transport wood upward along a steep slope to a transport at which logs are loaded onto a truck or the like. In methods and apparatuses from the prior art, a portion of a force required to move the transport vehicle and the wood is applied by the winch and a remaining portion by the transport vehicle itself, wherein, for example, a fixed pulling force in the cable or a fixed winch speed are predetermined by the transport winch and a movement transverse to the cable direction is effected by the transport vehicle itself, typically manually controlled by a driver, in order to drive around rough terrain such as roots, rocks, or pits, for example.

It has been shown that, with apparatuses and methods from the prior art, on the one hand only a low efficiency is obtained and, on the other hand, an undesirably high degree of damage to the ground or to the floor of the forest occurs.

This is addressed by the invention. The object of the invention is to specify an apparatus of the type named at the outset with which wood can also be moved efficiently in steep terrain, wherein at the same time damage to the ground is to be reduced.

In addition, a method of this type is to be specified with which a low degree of damage to the ground with a simultaneously efficient transport is enabled.

According to the invention, the first object is attained with an apparatus of the type named at the outset which comprises a mobile winch and a mobile transport vehicle which can be connected to the winch via a cable and has a chassis, wherein the winch comprises a winch drive for winding and unwinding the cable and the transport vehicle comprises a travel drive for driving the chassis and wherein the transport vehicle and the winch are connected by a data connection, wherein the transport vehicle comprises a sensor for determining a direction of travel relative to the cable winch and wherein a data processing device is provided which is connected to the travel drive and the winch drive so that, using the data processing device, a cable speed and a travel drive speed can be adjusted in an automated manner depending on a direction of travel of the transport vehicle, in particular relative to a cable direction.

In the course of the invention, it was found that conventional apparatuses and methods exhibit a high degree of damage to the ground and a low efficiency because the actuation of the cable winch and the actuation of the travel drive are not coordinated with one another. For example, the travel drive works against the cable winch when the transport vehicle is moved transversely to the cable direction, for example in order to drive around a tree stump or the like. In the case of an apparatus embodied according to the invention, a coordination of the actuation of the travel drive and of the winch with one another now takes place so that, during a movement transverse to the cable direction for example, a cable winch speed or cable speed is reduced and only the travel drive is actuated accordingly. Only when the direction of travel of the transport vehicle essentially corresponds to the cable direction does the cable speed also match the travel drive speed at which the transport vehicle is moved. The damage to the ground previously caused by the deviation of the cable speed from the speed of the transport vehicle in the cable direction, which damage is produced by a bracing of the transport vehicle against the cable force, is thus avoided in a particularly simple manner. As a result, both a wear of the chassis and damage to the ground are prevented.

It is beneficial if the transport vehicle comprises a front carriage and a rear carriage connected to the front carriage about a roughly vertical rotation axis. This enables a particularly good steering of the transport vehicle, even in rough terrain. The front carriage and rear carriage can then be connected via an articulated steering, for example.

Particularly preferably, it is provided that the front carriage and rear carriage comprise separate chassis. The chassis can be embodied as tracked chassis, wheeled chassis, or the like, in order to brace the transport vehicle, together with a piece of wood that is to be transported, against a subsurface.

It is advantageous if the front carriage and rear carriage can be driven independently from one another, wherein in particular a driving force on the front carriage can deviate from a driving force on the rear carriage and/or a drive speed of the front carriage can deviate from a drive speed of the rear carriage. In principle, this can take place using different motors for the front carriage and rear carriage. However, it is also possible to provide only one motor, wherein a drive output of said motor is variably divided between the front carriage and rear carriage, for example by means of torque vectoring.

It has proven effective that the chassis of the transport vehicle is embodied as a tracked chassis. This enables a movement of the transport vehicle in rough terrain in a particularly simple manner.

It is beneficial if the transport vehicle comprises a clamping device for clamping wood, which clamping device is in particular connected to the chassis such that it can rotate about a vertical axis.

The clamping device can be embodied to pick up logs that are to be transported at one side so that, during a transport of the wood, the logs drag on the subsurface at a second end. It is preferably provided that the clamping device comprises two clamping legs which can pivot relative to one another about a roughly horizontal clamping axis, between which clamping legs logs can be clamped. This enables a particularly simple and, at the same time, robust clamping and transport of logs, even in rough terrain.

It is beneficial if the transport vehicle comprises an arm which is connected to the chassis such that it can rotate about a vertical axis, via which arm the cable can be coupled to the transport vehicle such that the transport vehicle can be moved by the cable. In this manner, an introduction of a pulling force applied via the cable, which pulling force is generated by the winch, into the transport vehicle is effected roughly centrally or close to the center of gravity, so that a beneficial introduction of the cable force into the transport vehicle is produced. It is particularly beneficial if the arm protrudes out of a center of the transport vehicle, for example by more than one meter, so that the cable of the winch can be eccentrically connected to the transport vehicle via the arm, wherein an introduction of force still takes place roughly centrally via the arm which can vertically rotate about the rotation axis roughly centrally on the transport vehicle. As a result, a beneficial introduction of force is ensured, wherein, due to the rotatable attachment of the arm about the vertical rotation axis, a collision of the cable with a piece of wood, likewise centrally attached to the transport vehicle, is simultaneously avoided, wherein the wood is normally also connected to the transport vehicle such that it can rotate about the vertical rotation axis, in particular via the clamping device.

Preferably, the clamping device is likewise arranged roughly centrally or close to the center of gravity on the transport vehicle so that, with the cable, force is introduced in the region of the clamping device in order to reduce a mechanical loading of components of the transport vehicle to the greatest possible extent.

It is particularly beneficial if the arm is connected to a central region of the transport vehicle, in particular a region centrally between the front carriage and rear carriage.

The transport vehicle can thus comprise, for example, a front carriage, a rear carriage which is connected to the front carriage such that it can rotate about a vertical axis, a clamping device which is connected the front carriage and rear carriage such that it can rotate about the vertical axis, and an arm which is connected to the front and rear carriages and to the clamping device such that said arm can rotate about the vertical axis, in order to enable a most effective possible transport of wood, even in rough terrain.

Particularly for the purpose of recording a path traveled, it is beneficial if the transport vehicle comprises a GPS sensor. As a result, it can be sufficient to manually travel a path between tree stumps, rocks, or the like one time with the transport vehicle, after which the corresponding path can be automatically reproduced and traveled by the transport vehicle using recorded GPS coordinates.

In this context, it is particularly beneficial if the transport vehicle can be actuated manually, in particular using a remote control, wherein a data processing device is provided with which a path that the transport vehicle travels during a manual actuation can be recorded, wherein the transport vehicle is configured to automatically travel routes corresponding to previously recorded paths.

When wood is removed on a slope, the winch is thus preferably first positioned at an upper end of the slope, after which, starting from a region close to the winch, felled logs are transported to the winch using the transport vehicle in order to be loaded onto a truck or the like in said location, after which logs from regions located increasingly farther away from the winch are transported to the winch. A path of the transport vehicle from a region close to the winch into a region located farther away from the winch can thereby be manually defined using the remote control in an initial movement, wherein said manually defined paths are recorded. In subsequent method steps, in which the transport vehicle is moved into regions located even farther away from the winch, the transport vehicle can then automatically travel previously recorded paths and only needs to be manually moved into those regions which were not yet driven through in the preceding method steps. A movement back to the winch from the regions distant from the winch can thus always take place in an automated manner along the path that was previously recorded on a path from the winch into the region distant from the winch. As a result, a method which can be implemented in a particularly efficient manner is obtained.

It has proven effective that the apparatus is configured to move the transport vehicle up a slope with the aid of the winch, wherein a division of a drive output between the winch and transport vehicle, or between the winch drive and travel drive, takes place such that only that portion of the drive output is applied by the transport vehicle which is necessary for a movement of the transport vehicle transverse to the cable direction, in order to minimize a load for a subsurface. This furthermore ensures that, on the transport vehicle itself, only a comparatively low drive output and a comparatively light energy storage element can be provided, so that an overall lightweight transport vehicle is obtained, whereby damage to the ground is further minimized. The transport vehicle, for instance, often cannot move along a direct connecting line of the transport vehicle and winch, for example due to a path that is blocked by tree stumps, and must be moved transversely to said connecting line or transversely to the cable direction. By coordinating the cable speed with the speed and direction of the transport vehicle, it can be easily prevented that the travel drive and winch drive work against one another and the subsurface is damaged.

The other object is attained according to the invention with a method of the type named at the outset, wherein the apparatus comprises a mobile winch and a mobile transport vehicle which is connected to the winch via a cable, wherein the apparatus is preferably embodied according to the invention, wherein the winch and transport vehicle are connected via a data connection during the method and a current direction of travel of the transport vehicle is detected in an automated manner, wherein during the movement of the transport vehicle to the winch, a cable speed and a travel drive speed are coordinated with one another by a data processing device depending on the direction of travel of the transport vehicle.

By coordinating the travel drive speed and the cable speed with one another depending on the direction of travel of the transport vehicle relative to the cable drive, it is prevented that the travel drive and winch work against one another, whereby both damage to the subsurface and also high mechanical loads on the transport vehicle can be avoided.

It is beneficial if the wood is transported from a region distant from the winch to a region close to the winch using the transport vehicle, after which the wood is unloaded from the transport vehicle in the region close to the winch and the transport vehicle is moved without a load from the region close to the winch into a region distant from the winch in order to pick up additional wood. Typically, the mobile winch is arranged at an upper end of a slope that was deforested and from which the wood is to be removed so that, from the mobile winch, a cable projects downward to the transport vehicle, to which cable the transport vehicle is attached, in particular such that it can be detached, in order to be able to pull the transport vehicle upward by means of the winch.

It is beneficial if the movement from the region close to the winch into the region distant from the winch takes place at least partially by a manual control, wherein a path which the transport vehicle travels during the manual control is recorded by a data processing device.

It has proven effective that the movement from the region close to the winch into the region distant from the winch takes place at least partially in an automated manner along a path recorded in a preceding method step. It is thus sufficient if new routes are manually defined. For example, when felled wood is removed on a steep slope, it is possible to start by removing wood from a region close to the winch, after which the transport vehicle is moved step-by-step into regions that are increasingly distant from the winch, wherein only in regions that are located farther away from the winch than regions that were already traveled through beforehand is it necessary to drive manually by means of the control, for example via a remote control, and known paths can be automatically traveled by the transport vehicle.

In principle, it would also be conceivable that the transport vehicle moves on the slope entirely automatically, for example as an autonomous vehicle which is controlled by means of sensors such as cameras, radar sensors, ultrasound sensors, and the like.

It is beneficial if a force applied to the transport vehicle by the winch and a force applied by a chassis of the transport vehicle are coordinated with one another by a data processing device such that a largest possible portion of a force necessary for a movement of the transport vehicle from a region distant from the winch into a region close to the winch is applied by the winch and the cable and only a force which exceeds said force, in particular for a movement transverse to the cable direction, is applied by the transport vehicle. This ensures minimal damage to the ground.

Additional features, advantages, and effects of the invention follow from the exemplary embodiment described below. In the drawings which are thereby referenced:

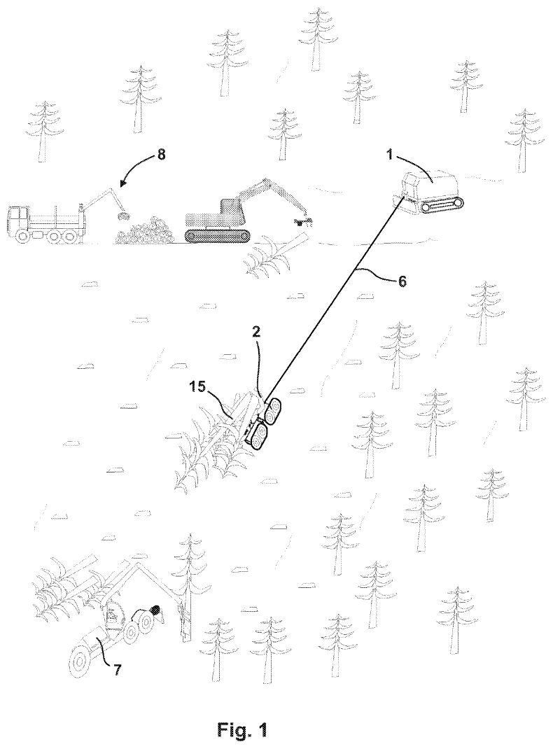

FIG. 1 shows a slope with an apparatus according to the invention in schematic illustration;

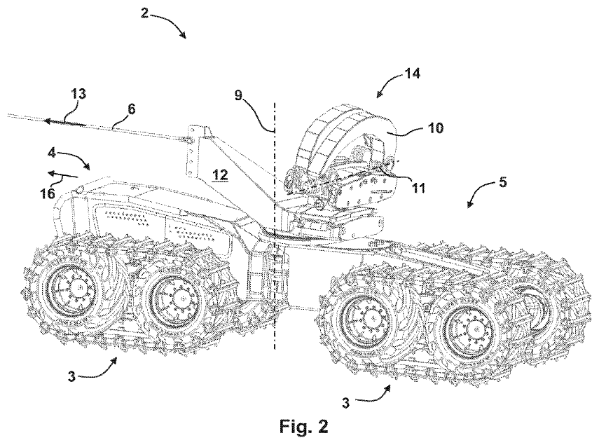

FIGS. 2 through 4 show a transport vehicle according to the invention in different views.

FIG. 1 shows a slope with an apparatus according to the invention while a method according to the invention is being carried out.

As can be seen, at an upper end of the slope, the mobile winch. 1 is arranged which is connected to a mobile transport vehicle 2 via a cable 6, with which transport vehicle 2 tree trunks that are felled in a lower region, or a region distant from the winch 1, of the slope using a harvester 7, for example, are transported upward along the slope into a region close to the winch 1, from which region the tree trunks are removed, for example by a truck 8. The winch 1 and transport vehicle 2 respectively comprise drives, wherein the winch 1 comprises a winch drive for winding and unwinding the cable 6 and the transport vehicle 2 comprises a travel drive for driving a chassis of the transport vehicle 2. In addition, the winch 1 and transport vehicle 2 are connected via a data connection, a wireless connection in the exemplary embodiment, so that the winch drive and chassis drive can be coordinated with one another by means of a data processing device which can be arranged, for example, in the winch 1, in the transport vehicle 2, or in a third location.

The transport vehicle 2 furthermore comprises one or more sensors, in particular a GPS sensor, an acceleration sensor, and/or a tilt sensor, with which a direction of travel 16 of the transport vehicle 2 and a cable direction 13 can be detected. The latter can also be detected via an angle sensor which is connected on one side to a front carriage 4 and/or rear carriage 5 of the transport vehicle 2 and to an arm 12 of the transport vehicle 2, via which arm 12, which is connected to the front carriage 4 and rear carriage 5 such that it can rotate about a vertical axis, the cable 6 is connected to the transport vehicle 2 so that the arm 12 is typically oriented in the cable direction 13. Data from the sensors can also be transmitted to the data processing device so that, using the data processing device, the winch drive and chassis drive can be coordinated with one another depending on a direction of travel 16 of the transport vehicle 2 relative to the cable direction 13, whereby, for example during a movement of the transport vehicle 2 transverse to the direction of travel 16, a correspondingly low cable speed can be set in order to prevent damage to the ground.

A transport of tree trunks on the illustrated slope typically begins in that tree trunks are picked up in a region close to the winch 1. To load and unload the tree trunks, apparatuses and methods known from the prior art can be relied on, for example loading cranes and the like. After a loading of the tree trunks onto the transport vehicle 2, said tree trunks are fixed on the transport vehicle 2, namely by means of the clamping legs 10 which can pivot about a horizontal clamping axis 11. The tree trunks are subsequently transported by the transport vehicle 2 to the winch 1, where the tree trunks are unloaded from the transport vehicle 2, for example onto a truck 8.

The unloaded transport vehicle 2 is then moved into a region located farther away from the winch 1, or a region distant from the winch 1, typically a region which is even farther below the winch 1.

A movement into said region distant from the winch 1 can take place manually, for example using a remote control, wherein the transport vehicle 2 is configured to record a path traveled, typically by means of one or more GPS sensors. The path traveled in this manner and recorded by means of the data processing device can then be automatically traveled by the transport vehicle 2 on a return path to the winch 1 or into the region close to the winch 1, so that no additional manual steering intervention is necessary.

In a further method step, wherein the transport vehicle 2 is moved into a region located even farther away from the winch 1, the transport vehicle 2 can then be moved in an automated manner to a previously reached point according to the recorded path, and only a yet unknown, new route therefore needs to be manually controlled in order to drive around tree stumps or rocks, for example. The manual control of the transport vehicle 2 can take place on the transport vehicle 2 itself or by means of a remote control.

In principle, an implementation with a transport vehicle 2 which can be moved fully autonomously would, of course, also be possible.

FIGS. 2 through 5 show a transport vehicle 2 according to the invention in different views.

As can be seen, the transport vehicle 2 comprises a front carriage 4 and a rear carriage 5 connected to the front carriage 4 about a vertical rotation axis 9, wherein the front carriage 4 and rear carriage 5 respectively comprise a tracked chassis 3. The transport vehicle 2 is thus embodied with an articulated steering. A motor is typically arranged in the front carriage 4, although an embodiment is, in principle, also possible wherein motors are positioned both in the front carriage 4 and in the rear carriage 5 in order to drive the individual chassis independently from one another. If a motor is only arranged in the front carriage 4, both the chassis of the front carriage 4 and the chassis of the rear carriage 5 are still typically driven by the motor, wherein it can in this case also be provided that the chassis of the front carriage 4 and rear carriage 5 can be driven independently from one another, in particular using different forces, which can be implemented by means of torque vectoring, for example.

In the position illustrated in FIG. 2, the direction of travel 16 approximately corresponds to the cable direction 13. Thus, in this position, the force required to drive the transport vehicle 2 can, in principle, be applied nearly entirely by the winch 1, so that, being controlled by the data processing device, the motor of the transport vehicle 2 can be operated at a correspondingly lower output, whereby a low fuel requirement in the transport vehicle 2 and therefore a low number of refuelings are achieved.

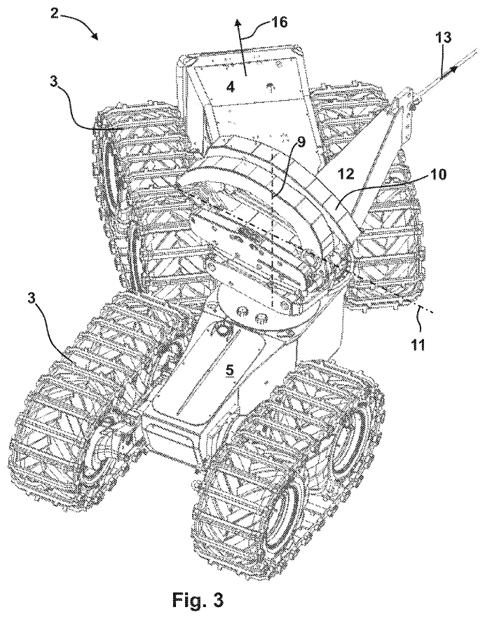

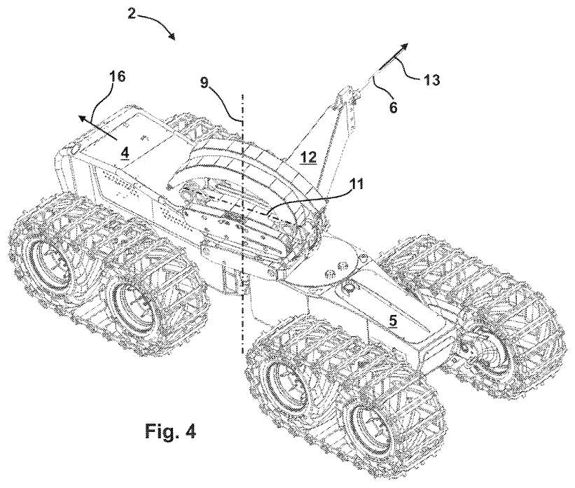

In the situations illustrated in FIGS. 3 and 4, the cable direction 13 deviates more markedly from the direction of travel 16 of the transport vehicle 2. This case can arise, for instance, if the transport vehicle 2 is moved transversely to the slope direction, for example in order to drive around a tree stump or a rock. In this case, a cable speed is reduced so that the cable speed corresponds only to the portion of the travel speed of the transport vehicle 2 in the cable direction 13. In this manner, the transport vehicle 2 is stabilized by the cable 6 or the winch 1 in the cable direction 13, in particular in the vertical direction, and a movement transverse to the cable direction 13 occurs through the travel drive, so that the travel drive is actuated more heavily in these situations than in the situation illustrated in FIG. 1.

As illustrated, the transport vehicle 2 comprises a clamping device 14 centrally arranged between the front carriage 4 and rear carriage 5 for clamping logs 15, which clamping device 14 comprises two clamping legs 10 which can pivot relative to one another about a roughly horizontal clamping axis 11. The clamping device 14 is connected to the front carriage 4 and rear carriage 5 such that it can rotate about the vertical rotation axis 9, so that the logs 15 can likewise be connected to the transport vehicle 2 such that they can rotate about the vertical rotation axis 9.

In addition, an arm 12 is connected to the front carriage 4 and rear carriage 5 such that it can pivot about the vertical rotation axis 9, through which arm 12 a cable force can be introduced into the transport vehicle 2.

As can be seen, the arm 12 can be connected to the cable 6, which can be wound and unwound by the winch 1. The arm 12 extends from a central region of the transport vehicle 2 into a lateral region and protrudes, so that a collision of the arm 12 with the logs 15 that are to be transported is avoided.

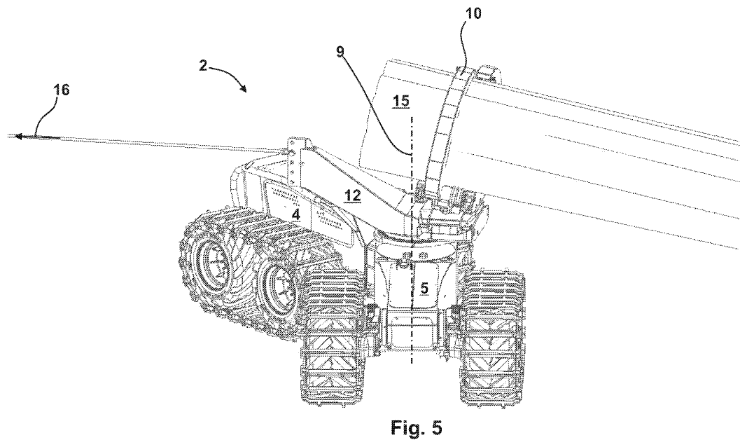

FIG. 5 shows the transport vehicle 2 with logs 15 clamped in the clamping device 14. As can be seen especially well in this case, both a force of the logs 15 and a cable force are introduced into the transport vehicle 2 roughly centrally, wherein a collision of the loas 15 with the arm 12 or the cable 6 is reliably prevented by a projection of the arm 12.

An apparatus embodied according to the invention and a corresponding method are particularly well suited for transporting logs 15 in rough, steep terrain without damaging a subsurface. At the same time, a working-against-one-another by the winch drive and chassis drive, which can respectively comprise a diesel engine with 300 hp to 500 hp, is avoided to the greatest possible extent, so that mechanical loads on the transport vehicle 2 are reduced and a high efficiency can be obtained, wherein wear parts in particular only need to be replaced very rarely. Due to the possibility of the transport vehicle 2 automatically traveling previously recorded routes at a later point, a particularly efficient method is enabled which can be carried out with an especially low use of personnel and, at the same time, with process reliability.

1. An apparatus for transporting wood in steep terrain, comprising a mobile winch and a mobile transport vehicle which can be connected to the winch via a cable and has a chassis, wherein the winch comprises a winch drive for winding and unwinding the cable and the transport vehicle comprises a travel drive for driving the chassis and wherein the transport vehicle and the winch are connected by a data connection, wherein the transport vehicle comprises a sensor for determining a direction of travel relative to the cable winch and wherein a data processing device is provided which is connected to the travel drive and the winch drive so that, using the data processing device, a cable speed and a travel drive speed can be adjusted in an automated manner depending on a direction of travel of the transport vehicle.

2. The apparatus according to claim 1, wherein the transport vehicle comprises a front carriage and a rear carriage connected to the front carriage about a roughly vertical rotation axis.

3. The apparatus according to claim 2, wherein the front carriage and rear carriage comprise separate chassis.

4. The apparatus according to claim 2, wherein the front carriage and rear carriage can be driven independently from one another, wherein in particular a driving force on the front carriage can deviate from a driving force on the rear carriage and/or a drive speed of the front carriage can deviate from a drive speed of the rear carriage.

5. The apparatus according to claim 1, wherein the chassis of the transport vehicle is embodied as a tracked chassis.

6. The apparatus according to claim 1, wherein the transport vehicle comprises a clamping device for the clamping of wood, which device is in particular connected to the chassis such that it can rotate about a vertical axis.

7. The apparatus according to claim 6, wherein the clamping device comprises two clamping legs which can pivot relative to one another about a roughly horizontal clamping axis, between which clamping legs logs can be clamped.

8. The apparatus according to claim 1, wherein the transport vehicle comprises an arm which is connected to the chassis such that it can rotate about a vertical axis, via which arm the cable can be coupled to the transport vehicle such that the transport vehicle can be moved by the cable.

9. The apparatus according to claim 8, wherein the arm is connected to a central region of the transport vehicle, in particular a region centrally between the front carriage and rear carriage.

10. The apparatus according to claim 1, wherein the transport vehicle comprises a GPS sensor.

11. The apparatus according to claim 1, wherein the transport vehicle can be actuated manually, in particular using a remote control, wherein a data processing device is provided with which a path that the transport vehicle travels during a manual actuation can be recorded, wherein the transport vehicle is configured to automatically travel routes corresponding to previously recorded paths.

12. The apparatus according to claim 1, wherein the apparatus is configured to move the transport vehicle up a slope with the aid of the winch, wherein a division of a drive output between the winch and transport vehicle takes place such that only that portion of the drive output is applied by the transport vehicle which is necessary for a movement of the transport vehicle transverse to the cable direction, in order to minimize a load for a subsurface.

13. A method for transporting wood in steep terrain using an apparatus which comprises a mobile winch and a mobile transport vehicle connected to the winch via a cable, in particular using an apparatus according to claim 1, wherein the winch and transport vehicle are connected via a data connection during the method and a current direction of travel of the transport vehicle is detected in an automated manner, wherein during the movement of the transport vehicle to the winch, a cable speed and a travel drive speed are coordinated with one another by a data processing device depending on the direction of travel of the transport vehicle.

14. The method according to claim 13, wherein the wood is transported from a region distant from the winch to a region close to the winch using the transport vehicle, after which the wood is unloaded from the transport vehicle in the region close to the winch and the transport vehicle is moved without a load from the region close to the winch into a region distant from the winch in order to pick up additional wood.

15. The method according to claim 14, wherein the movement from the region close to the winch into the region distant from the winch takes place at least partially by a manual control, wherein a path which the transport vehicle travels during the manual control is recorded by a data processing device.

16. The method according to claim 15, wherein the movement from the region close to the winch into the region distant from the winch takes place at least partially in an automated manner along a path recorded in a preceding method step.

17. The method according to claim 13, wherein a force applied to the transport vehicle by the winch and a force applied by a chassis of the transport vehicle are coordinated with one another by the data processing device such that a largest possible portion of a force necessary for a movement of the transport vehicle from a region distant from the winch into a region close to the winch is applied by the winch and the cable and only a force which exceeds said force, in particular for a movement transverse to the cable direction, is applied by the chassis.
